(19) United States
(12) Patent Application Publication
(10) Pub. No.: US 2003/0184781 A1
(43) Pub. Date: Oct. 2, 2003

(54) Adjusting printer driver settings

(76) Inventor: John D. Laughlin, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/106,232

(22) Filed: Mar. 27, 2002

(51) Int. Cl. G06F 15/00; B41B 1/00

(52) U.S. Cl. 358/1.13

(57) ABSTRACT

A method of adjusting printer driver options includes receiving at least one parameter related to a printer driver setting; saving the at least one parameter; and associating the at least one parameter with an application.

### FIELD OF THE INVENTION

The present invention is generally related to printer drivers. More particularly, the present invention is related to associating printer driver settings with an application.

### BACKGROUND OF THE INVENTION

Typically, printing from a computer program occurs through the use of a printer driver. Upon either an application launch or during a print command load time, the program will call an instance of the printer driver and provide the user with an interface to set the desired printer driver options, e.g., double-sided printing, paper size, orientation, color, ink volume, etc. Printer driver options themselves may be referred to by many names, e.g., printer options, print settings, options, settings, driver options, driver settings, etc. The next time the user would like to print, depending on the program and driver being used, either the print command will call a new instance of the print driver that must then be configured to contain the desired printer driver options, or it will reuse the instance of the driver used earlier. In the case where the driver being used is the same as the one used earlier, the user must select any printer driver options that differ from those chosen the previous time.

Typically, a computer user may always want to print with a particular set of printer driver options when printing from a specific application. For example, a user may always wish to print on A4 paper when using WORDPERFECT, or print in color when using PHOTOSHOP. Currently, when attempting to print from an application, a user must first specify the printer driver options each time in order to ensure that the printer driver options are appropriate. In some applications that involves choosing to print, choosing printer properties, and manually selecting each desired option. Using some additional utilities, such as HEWLETT-PACKARD's Quick Sets, it is feasible to save those printer driver options and in the future to select that saved set of printer driver options rather than selecting each option individually. However, considering that the average PC user has close to 50 programs installed at a time, invariably, these steps require time and identification of printer driver options, as well as the ability to remember to perform these steps before ultimately giving the print command. Failure to perform these steps can result in unusable copies which wastes paper, ink, and time.

### SUMMARY OF THE INVENTION

An embodiment of the invention includes a method of adjusting printer driver options. The method includes receiving at least one parameter related to a printer driver setting; saving the at least one parameter; and associating the at least one parameter with an application.

Another embodiment of the invention includes a method comprising receiving a request to print information from an application; and automatically loading at least one parameter associated with the application to a printer driver.

The methods of the present invention include steps that may be performed by computer-executable instructions executing on a computer-readable medium.

In yet another embodiment of the invention, a computer system comprises a computing device configured to be connected to a printing device. The computing device executes at least one application and a printer driver associated with the printing device. The printer driver is operable to associate the at least one parameter with the application.

In yet another embodiment of the invention, a computing device comprises a means for receiving at least one parameter related to a printer driver setting; a means for saving the at least one parameter; and a means for associating the at least one parameter with an application.

In yet another embodiment of the invention, a computing device comprises a means for receiving a request to print information from an application; and a means for automatically loading at least one parameter associated with the application to a printer driver.

### BRIEF DESCRIPTION OF THE DRAWINGS

The present invention is illustrated by way of example, and not limitation, in the accompanying figures in which like numeral references refer to like elements, and wherein:

FIG. 1 is a diagram of an exemplary computing system employing principles of the invention;

FIG. 2 is a flowchart of an exemplary method employing principles of the invention; and

FIG. 3 is a flowchart of an exemplary method employing principles of the invention.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

Preferably, the invention provides a user with the ability to automatically configure printer driver options based upon which software program is requesting access to a printer driver for printing. The same printer driver options may be loaded automatically for each document printed from the same program even though a different program will load and utilize different printer driver options.

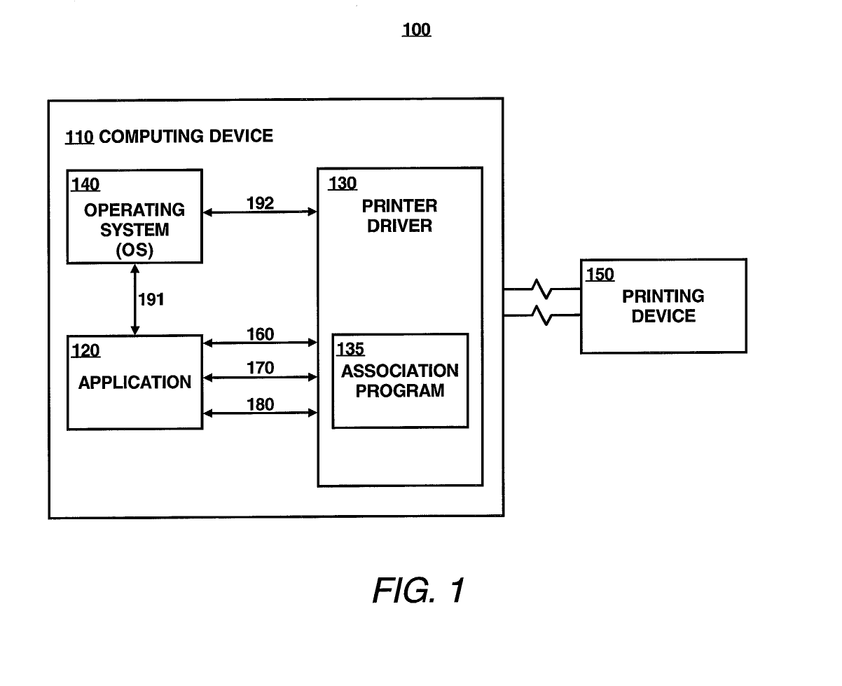

FIG. 1 is a diagram of an exemplary software system 100 that may employ principles of the invention. This system 100 illustrates the interaction between a computing device 110 and a printing device 150, including the interaction of software modules within the computing device 110 that handle the flow of information between the various pieces of software used for printing. As shown in FIG. 1, the computing device 110 includes an application 120, a printer driver 130 including the association program 135, and an operating system (OS) 140. System 100 also includes data flows 160, 170, 180, 191, and 192. Although not shown, it will be apparent to one of ordinary skill in the art that the computing device 110 may include multiple applications and printer drivers running on one or more OSs. Furthermore, the computing device 110 may be connected to multiple printing devices.

The system 100 comprises a computing device 110 that is connected to the printing device 150. The computing device 110 may include a traditional personal computer, or any other device (e.g., a web server, digital camera, palm computing device, etc.) that can interface with the printing device 150 and has the capability of running applications which may print via the printing device 150. The connection from the computer 110 to the printing device 150 may be the traditional printer cable, or any other method of connecting to a printer used in the art, e.g., a remote network connection, a wireless network connection, an infrared connection, etc. The printing device 150 may be any device to which information can be printed, e.g., an inkjet printer, a laser printer, a photo printer, etc.

The application 120 is also commonly referred to as a program. This application 120 refers to any computer program that is capable of issuing any type of request, either directly or indirectly, to print information. Examples of an application 120 include, but are not limited to, commonly used programs, such as word processors, spreadsheets, browsers, imaging programs, etc. Since the invention is not platform or even machine specific, other examples of applications 120 include any program written for any other device, including handheld or multimedia devices, that is capable of printing.

The printer driver 130 is software interfacing with the application 120 (or operating system 140) and the printing device 150. The printer driver 130 may be configured to work with a specific OS 140, application 120, and printer 150, such that different device configurations may use different printer drivers. The invention can be utilized with any of these configurations and printer drivers 130.

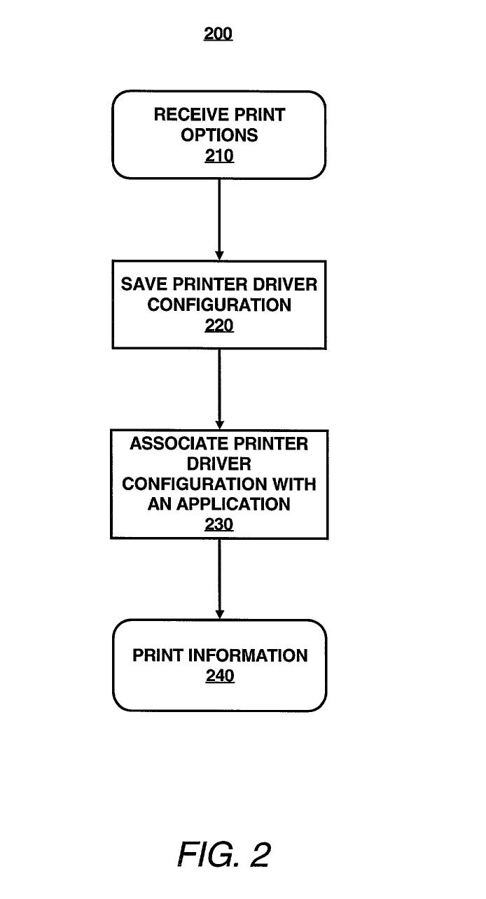

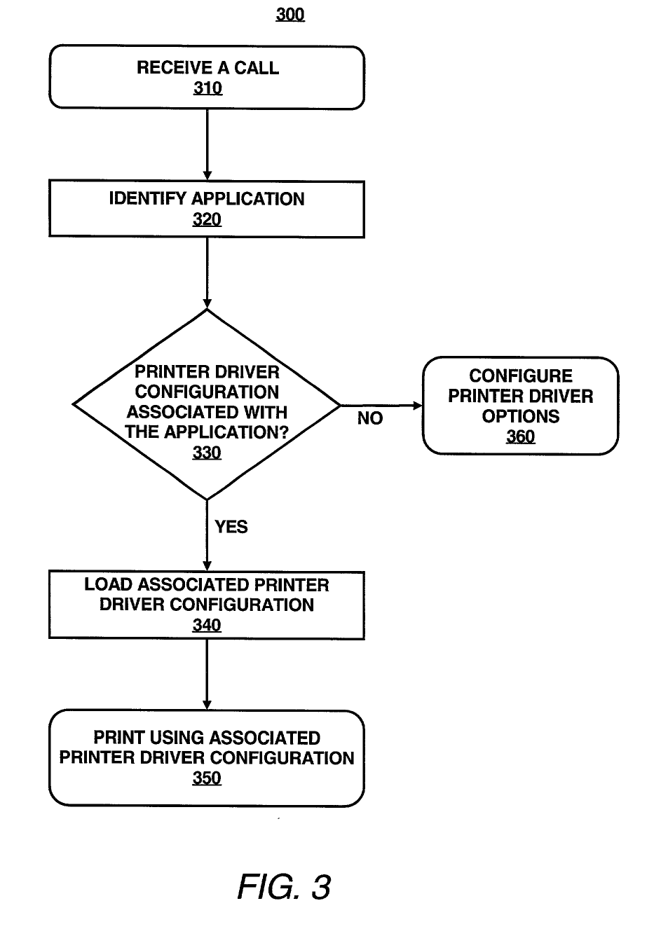

The association program 135 automatically configures the print options for an application as shown in FIG. 2 and FIG. 3 and described in detail below. While the association program 135 is shown as part of the printer driver 130, it will be apparent to one of ordinary skill in the art that the association program 135 may include a separate software program interfacing with the printer driver 130, the application 120 and/or the OS 140. Alternatively, the association program 135 may be incorporated in the printer driver 130 using know programming techniques.

The OS 140 may be any platform capable of running an application 120. For example, the OS may be in the MICROSOFT WINDOWS family, or it may be a MACINTOSH OS, PALM OS, a JAVA based OS, or the OS of any other device, including but not limited to handheld or multimedia devices.

Data flows 160-180 and 191-192 illustrate the flow of data according to an embodiment of the invention. Data flow 160 may include a call initiated by the application 120 to load the printer driver 130. The application 120 may load the printer driver 130 by calling the printer driver 130 upon application launch time, or the application 120 may perform a similar function at the time when the print function is requested. The data flow 170 includes parameters transmitted from the application 120 to the printer driver 130. A parameter may include a printer driver option, application identity information, or any other data transmitted to the printer driver 130 that is not intended to be output by the printing device 150. The association program facilitates storing a printer driver configuration for each application, such that print options are automatically configured for each application 120. The data flow 180 may include a query initiated by the printer driver 130 to receive more information (e.g., application identifier, and the like) from the application 120. In other embodiments of the invention, similar data flows 191 and 192 may use the OS 140 as an intermediary between the application 210 and the printer driver 220. In these embodiments, data flows 191 and 192 may combine to perform the same functions as data flow 160, 170, or 180. Therefore, it is important to note that one skilled in the art can see how the OS 140 may or may not be used to automatically configure print settings for the application 120. Furthermore, one skilled in the art can see how trends in programming may combine the OS 140 and the application 120 to the point where they would be indistinguishable.

An embodiment of the system 100 allows for the loading of the printer driver 130 at the time of the launching of the application 120. In this embodiment, the application 120 calls (e.g., in the data flow 160) the printer driver 130 and passes parameters to the printer driver 130 that indicate, among other things, which application 120 has made a call to the printer driver 130 and which printer driver options or parameters have been received (e.g., in the data flow 170).

In another embodiment, the printer driver 130 could be used by more than one application. In this embodiment, the printer driver 130 may receive a call to print, and it is possible that the parameters passed to the printer driver 130 (e.g., in the data flow 160) did not include an application identifier. In this circumstance, the printer driver 130 could either poll each application or query the OS 140 to determine which application 120 made the print call.

FIG. 2 is a flow chart illustrating an exemplary method 200 for automatically configuring printer driver options using the association program 135. In step 210, the association program 135 receives the printer driver options. The step 210 of receiving printer driver options may include receiving user input that configures any of the printer driver options that may be available to the printer driver. Examples of printer driver options that may be set at this point are page-size, orientation, ink volume, color, double or single sided printouts, etc. A user may select these printer driver options from within the print driver properties dialogue box invoked from the application 120 or from the OS 140. This is done, by way of example, in Word for MICROSOFT WINDOWS, by selecting the print function and clicking on the properties button within the print function. The association program 135 receives these selections. The association program 135 may also receive other selections which are not changed by the user. A driver configuration for a particular application consists not just of the selections that the user has made, but also includes the current settings of configurable features which the user has not changed. For example, the driver configuration may include settings that the user didn't select, such as paper size, print quality, etc. Often, these “implied” parameters (settings) would be default values, but they need not be.

In step 220, the association program 135 saves the received selections of printer driver options. The selected printer driver options may be saved as part of the association program 135 and or as an external file. In any event, the printer driver options may be saved, such that they are not lost when power is removed from the computing device 110.

In step 230, the associations program 135 associates the selected printer driver options with an application. The step of associating may include providing those printer driver options with a link to the application 120 from which they were received. For example, if the printer driver options are received from the printer dialogue box within Word, the association program 135 associates the selected printer driver options with the Word application 120. Subsequently, the associated printer driver options are the Word printer driver options and are used each time the printer driver 130 prints a Word document.

In step 240, the association program 135 uses the saved 220 printer driver options for printing from the application 120 with which the printer driver options are associated in step 230. These printer driver options are also automatically used every time the user prints from the application 120 as will be described in further detail in FIG. 3.

One with ordinary skill in the art can easily see how one or more of the steps in the method 200 could be combined to form fewer steps or even one step and how some or all of the steps could be made invisible to the user. For example, once the printer driver options are received in step 210, the association program 135 may automatically save the printer driver options and associate them with the application 120 from which they were received as one step. Another embodiment of the association program 135 may associate the printer driver options and then save them automatically, or may require user input at any step along the way.

FIG. 3 is a flow chart describing an exemplary method 300 in which an embodiment of the invention is utilized to automatically configure the printer driver 130 based upon the results of method 200. In step 310, the association program 135 receives a call from an application 120 to load the print driver 130. As mentioned above, this may occur at launch time of the application 120 or at the launch of the print routine.

In step 320, the association program 135 identifies which application 120 is making the call. For example, the call may include information identifying the application 120 making the call to the printer driver 130, and the association program 135 extracts that information from the call. Also, the association program may poll applications to identify which application 120 made the call or query the OS (e.g., transmit a request to the OS and receive an identity of the application making the call from the OS) to identify the application 120 making the call.

In step 330, the association program 135 determines whether any printer driver options are associated with the application making the call. If printer driver options are associated with the application 120 making the call, the association program 135 loads those printer driver options (step 340) and then prints (step 350) using the printer driver options associated with the application 120 making the call.

If printer driver options are not associated with the application 120 making the call, as determined in step 330, the association program 135 may configure printer driver options for the application 120 using, for example, the method 200, shown in FIG. 2 (step 360). For example, the user may be prompted with the option to save any adjusted print driver options, such that these options are used for subsequent printing from the application 120. As with method 200, if the user does not alter the printer driver options, the association program 135 may simply use default settings.

One skilled in the art could see how the user could be provided with more choices, or how the invention could be automated to make one or more of the steps in the method 300 invisible to the end user. The scope of the invention includes any automation of the setting of printer driver options that is associated with a specific application or group of applications.

While this invention has been described in conjunction with the specific embodiments thereof, it is evident that many alternatives, modifications and variations will be apparent to those skilled in the art. There are changes that may be made without departing from the spirit and scope of the invention.

What is claimed is:

1. A method of adjusting printer driver settings comprising:
receiving at least one parameter related to a printer driver setting;
saving said at least one parameter; and
associating said at least one parameter with an application.

2. The method of claim 1, further comprising a step of printing information from said application using the at least one parameter.

3. The method of claim 1, further comprising a step of receiving a call from said application to print information.

4. The method of claim 3, further comprising steps of:
determining whether one or more parameters are associated with said application;
loading said at least one parameter associated with said application in response to determining said at least one parameter is associated with said application; and
configuring one or more parameters related to a printer driver setting in response to no option being associated with said application.

5. A method of adjusting printer driver options comprising:
receiving a request to print information from an application; and
automatically loading at least one parameter associated with said application to a printer driver.

6. The method of claim 5, further comprising a step of identifying said application requesting to print information.

7. The method of claim 6 wherein said step of identifying comprises:
querying an operating system to determine an identity of said application; and
receiving said identity from said operating system.

8. The method of claim 6 wherein said step of receiving at least one parameter comprises receiving said at least one parameter directly from said application.

9. The method of claim 6 wherein said step of receiving at least one parameter comprises receiving said at least one parameter directly from an operating system.

10. The method of claim 6 wherein the step of querying comprises:
querying the operating system to determine the application's identity; and
receiving a parameter indicating the program's identity.

11. A computer readable medium on which is embedded a callable interface program program, the program performing a method comprising:
receiving at least one parameter related to a printer driver setting;
saving said at least one parameter; and
associating said at least one parameter with an application.

12. The computer readable medium of claim 11, wherein said method further comprises a step of printing information from said application using the at least one parameter.

13. The computer readable medium of claim 11, wherein said at least one parameter includes one or more of page-size, orientation, ink volume, color, double-sided printout and single-sided printout.

14. The computer readable medium of claim 13, wherein said method further comprises steps of method of:
determining whether one or more parameters are associated with said application;
loading said at least one parameter associated with said application in response to determining said at least one parameter is associated with said application; and
configuring one or more parameters related to a printer driver setting in response to no option being associated with said application.

15. The computer readable medium of claim 11, wherein said method further comprises steps of:
receiving a request to print information from said application; and
automatically loading said at least one parameter associated with said application to said callable interface program.

16. The computer readable medium of claim 15, wherein said method further comprises a steps of identifying said application requesting to print information.

17. The computer readable medium of claim 16, wherein said step of identifying comprises:
querying an operating system to determine an identity of said application; and
receiving said identity from said operating system.

18. The computer readable medium of claim 11, wherein said step of receiving at least one parameter comprises receiving said at least one parameter directly from said application.

19. The computer readable medium of claim 11, wherein said step of receiving at least one parameter comprises receiving said at least one parameter directly from an operating system.

20. The computer readable medium of claim 11, wherein said callable interface program includes a printer driver.

21. A computer system comprising a computing device configured to be connected to a printing device, wherein the computing device executes at least one application and a printer driver associated with the printing device, and the printer driver is operable to associate the at least one parameter with the application.

22. The computer system of claim 21, wherein the at least one parameter includes a plurality of parameters input by a user.

23. The computer system of claim 21, wherein the printer driver is operable to receive a request to print information from the application and automatically loading the at least one parameter associated with the application.

24. A computing device comprising:
means for receiving at least one parameter related to a printer driver setting;
means for saving said at least one parameter; and
means for associating said at least one parameter with an application.

25. The computing device of claim 24, further comprising means for receiving a call from said application to print information.

26. The computing device of claim 25, further comprising:
means for determining whether one or more parameters are associated with said application;
means for loading said at least one parameter associated with said application in response to determining said at least one parameter is associated with said application; and
means for configuring one or more parameters related to a printer driver setting in response to no option being associated with said application.

27. A computing device comprising:
means for receiving a request to print information from an application; and
means for automatically loading at least one parameter associated with said application to a printer driver.

28. The computing device of claim 27, further comprising a means for identifying said application requesting to print information.

29. The computing device of claim 28, wherein the means for identifying is operable to query an operating system to determine an identity of said application and receive said identity from said operating system.

30. The computing device of claim 28, wherein the means for identifying is operable to query the operating system to determine the application's identity and receive a parameter indicating the program's identity.
